(19) United States
(12) Patent Application Publication
(10) Pub. No.: US 2024/0372060 A1
(43) Pub. Date: Nov. 7, 2024

(54) NANOSTRUCTURED SEED LAYERS FOR LITHIUM METAL DEPOSITION

(71) Applicants: Sourav Roger Basu, El Cerrito, CA (US); Jonathan Tan, Oakland, CA (US); Michael D Slater, San Jose, CA (US); Donald A Zehnder, San Carlos, CA (US); Matthew A Kolaczkowski, Oakland, CA (US); Bonil Koo, San Leandro, CA (US)

(72) Inventors: Sourav Roger Basu, El Cerrito, CA (US); Jonathan Tan, Oakland, CA (US); Michael D Slater, San Jose, CA (US); Donald A Zehnder, San Carlos, CA (US); Matthew A Kolaczkowski, Oakland, CA (US); Bonil Koo, San Leandro, CA (US)

(21) Appl. No.: 18/573,945

(22) PCT Filed: Jul. 1, 2022
(86) PCT No.: PCT/US2022/073393

§ 371 Date: Dec. 22, 2023

Related U.S. Application Data
(60) Provisional application No. 63/218,047, filed on Jul. 2, 2021.

(51) Int. Cl. H01M 4/04; H01M 10/056

(52) U.S. Cl. CPC H01M 4/0452; H01M 4/0404; H01M 10/056; H01M 2300/0065; H01M 2300/0091

(57) ABSTRACT

A battery can include one or more battery cells. An individual battery cell can comprise an electrode layer including a seed layer comprised of a number of fused nanoparticles. The electrode layer can also include a lithium metal layer disposed on the number of fused nanoparticles. The electrode layer can be formed by producing. on a current collector layer. a seed layer that includes nanoparticles. The seed layer can be formed from a formulation that includes nanoparticles having ligands coupled to the nanoparticles and then removing the ligands using one or more thermal treatment processes and/or one or more chemical treatment processes. In addition to removing the ligands. the one or more thermal treatment processes and/or one or more chemical treatment processes can cause the nanoparticles to be fused and produce nanoparticle clusters. The nanoparticle clusters can be arranged such that the seed layer has an amount of porosity.

### CROSS-REFERENCE TO RELATED APPLICATION

This patent application claims the benefit of U.S. Provisional Application Ser. No. 63/218,047, filed on Dec. 31, 2021, which is incorporated by reference herein in its entirety.

### BACKGROUND

Lithium-Ion Batteries (LIBs) can be used in a number of applications, such as in portable electronics, electric vehicles, and electrified aviation. State of the art LIBs possess limited cell-level energy density due to the low specific energy of their Lithium-containing active materials, namely the graphite anode and the metal oxide or metal phosphate cathode. Improvements in the energy density of LIBs may lead to increased adoption and viability as an energy source.

One way to improve the energy density of LIBs is to replace the standard graphite anode with an anode composed of Li metal. Li metal possesses a specific capacity of ˜3860 mAh/g, more than ten times that of graphite. Furthermore, the potential at which Li metal is deposited onto a current collector from a typical Li battery electrolyte (0V vs. Li/Li⁺, −3.04V vs. standard hydrogen electrode (SHE)) is also improved relative to graphite; graphite typically intercalates Li at a range of voltages from 0.005 to 0.5V vs. Li/Li⁺. The combination of these two attributes results in an improved energy density of Li metal anodes as compared to graphite anodes.

However, the widespread adoption of Li metal as an anode material has been impeded due to several challenges. Primarily, the morphology of Li metal deposited on the anode current collector during battery charging is typically highly non-uniform and composed of tree-like structures (“dendrites”) or otherwise uneven geometries that tend to become detached from the remainder of the Li metal anode during repeated battery cycling. Such detached Li eventually becomes electrochemically inactive and no longer contributes to battery capacity. In some instances, Li metal dendrites can grow sufficiently long so as to pierce the anode-cathode polymer separator and form an electrical short to the cathode. In these instances, the joule heating resulting from the energy discharged through the electrical short is often enough to force the battery cell into uncontrolled thermal runaway and conflagration.

A related deleterious outcome of uneven Li metal deposition is the continued formation and disintegration of a parasitic surface degradation product formed at the Li metal-electrolyte interface, which is commonly termed solid-electrolyte-interphase (or “SEI”). The formation of SEI results from the thermodynamic instability of typical electrolyte solvents at battery operating voltages. At the anode, in particular, a reductive process dominates whereby the electrolyte solvent molecule first cleaves, then combines with nearby Li ions, and finally precipitates an insoluble, irreversible Li-containing compound. Like detached Li metal, SEI compounds are also electrochemically inactive and contribute to capacity loss. In state-of-the-art LIBs, the SEI forms during the first few charge cycles on the graphite anode surface and then largely limits its own formation in subsequent cycles due to its electrically insulating nature. In graphite anodes, the relatively low volumetric change upon lithiation/de-lithiation (˜10%), coupled with the stability of the host graphite lattice itself, yields an anode-electrolyte interfacial SEI that remains mostly intact throughout the LIB's cycle lifetime. In contrast, due to the unpredictable and uneven deposition of Li metal, large volumetric changes are experienced by SEI on Li metal surfaces during every charge-discharge cycle, resulting in rapid disintegration of the SEI.

Further, a practical shortcoming of the Li metal anode is the impact of Li metal deposition on the overall cell geometry itself. At the beginning of a LIB's life, all available Li is initially stored in the cathode. In Li metal anode battery cell design, the anode at the beginning of life is a bare foil current collector. Then, during the first charge of the battery, Li from the cathode is transported via the electrolyte to the surface of the current collector, where it electrodeposits as layers of Li metal. During this process, the cathode material undergoes little volumetric change, but the electrodeposited Li metal contributes several additional microns per anode-cathode couple. For example, a cathode with areal capacity of ˜3 mAh/cm² will result in a Li metal thickness of ˜15 μm at full charge, assuming bulk Li metal density. In most instances, however the Li metal thickness actually exceeds this value because of the previously described uneven, low-density Li metal morphology. Therefore, in a battery cell composed of several stacked anode-cathode couples, the overall impact to the battery cell thickness can be an increase of several 10's to 100's of microns during the charging process. Given that typical battery cell housings are not engineered with extra volume to accommodate such an expansion in thickness, the deposition of Li metal presents a practical barrier to adoption.

The morphology of electrodeposited Li metal largely depends on the current density at which it is deposited. For example, deposition current densities of ˜0.1 mA/cm² can provide relatively uniform lateral electrodeposition of Li metal, but current densities greater than 1 mA/cm² begin to yield dendritic growth. In a scenario where a Li metal anode is paired with a cathode of >3 mAh/cm² areal capacity, a charge current density of 0.1 mA/cm² represents a charge rate of C/30, 120× lower than the desired minimum fast charge rate of 4 C for EVs. Furthermore, electrodeposited Li metal layers having a fast charge rate of 4 C are typically realized when a moderate compressive stress is applied to the full cell stack. A sufficiently stiff support structure that can withstand this pressure adds substantial mass that diminishes the specific energy gains of using the Li metal anode. Additionally, this application of pressure adds cost and erodes the economic viability of Li metal anodes.

One way to maintain relatively low Li metal electrodeposition current densities and promote lateral growth is to increase the effective surface area of the current collector. For example, a highly textured current collector may have an effective surface area that is orders of magnitude greater than the planar surface area. Such a current collector can accommodate high charge rates from a cathode providing >3 mAh/cm² planar areal capacity, because the effective current density can be maintained well within the acceptable range (e.g. <0.1 mA/cm²) for lateral growth of Li metal.

Furthermore, by providing a stable, volumetrically unchanging scaffold onto which thin layers of Li metal are plated, textured three-dimensional current collectors effectively eliminate the problem of cell swelling during each charge cycle.

Most efforts to date for generating textured current collectors for Li metal deposition have centered around porous metallic “foams”. Such structures are typically fabricated by etching solid planar metallic foils to yield highly porous textured microstructures, or by coating foams of other materials (such as carbon) with thin metallic overlayers. While such metallic foams have yielded some success with regards to preventing dendrite growth during Li metal deposition, they do not provide the most efficient and optimal architecture. Usually, such foams possess high porosity but still low effective surface area as a function of foam thickness due to the relatively large average pore size. The end result is that these foams tend to be several dozens to hundreds of microns thick themselves-thereby greatly reducing the effective volumetric energy density of the resulting battery cell.

Furthermore, the fabrication of the foam adds an additional step to the battery manufacturing process, and can often be a costly technique (if for instance, the foam is generated by a high-temperature pyrolysis process).

In addition to ultimately providing an insufficient amount of surface area for Li deposition, the thickness of the Li metal layer on all surfaces within the foam can exceed 100's of nm at full charge. At such repeated volume changes of the Li metal layer, any nascent SEI formed from previous cycles on the surface of the Li metal is still likely to disintegrate, thereby exposing fresh Li metal surface for new SEI to form during each cycle. This results in accelerated capacity fade and poor coulombic efficiency.

### SUMMARY

A seed layer for a Li metal anode can be generated that includes nanoparticles. The seed layer can be formed on a current collector layer and Li metal can be deposited on the seed layer. The seed layer can have an amount of porosity. In various examples, the seed layer can be formed from nanoparticles having ligands coupled to the nanoparticles and then removing the ligands using one or more thermal treatment processes and/or one or more chemical treatment processes. In one or more additional examples, the seed layer can comprise nanoparticles that are formed in situ, during the decomposition of molecular precursors. The nanoparticles of the seed layer can be present in nanoparticle clusters comprised of fused groups of nanoparticles. Li metal can be deposited on the seed layer to produce an anode of a battery cell.

In one or more examples, a method for producing a substrate comprising a nanostructured seed layer on one or more surfaces of a current collector can include providing an ink comprising a solution comprising at least ligand-functionalized nanoparticles and a solvent; applying a thin wet film of the ink to the current collector using a solution-phase thin-film coating process; drying the thin wet film to produce a thin dry film of ligand-functionalized nanoparticles; and performing one or more thermal treatments and/or chemical treatments to the thin dry film, thereby producing a substrate comprising a free-standing, porous nanostructured seed layer on one or more surfaces of a current collector.

In one or more examples, a method for producing a substrate comprising a nanostructured seed layer on one or more surfaces of a current collector can include providing an ink comprising a solution comprising at least one or more molecular precursors and a solvent. Additionally, a thin wet film of the ink can be applied to the current collector using a solution-phase thin-film coating process. One or more thermal treatments and/or chemical treatments can be performed with respect to the thin wet film, thereby producing a substrate comprising a free-standing, porous nanostructured seed layer on one or more surfaces of a current collector. In one or more exaples, the molecular precursors can include metalorganic compounds.

Additionally, the seed layer can be formed from a formulation including a solvent; a plurality of nanoparticles disposed within the solvent, the plurality of nanoparticles having one or more dimensions from about 0.5 nanometers to about 500 nm; one or more ligands coupled to individual nanoparticles of the plurality of nanoparticles, the one or more ligands having a molecular weight from 20 daltons (Da) to 10 kDa. The formulation can be characterized as an ink that is deposited onto a current collector layer of a battery cell.

Further, a method for producing a lithium-metal coated substrate can include providing a substrate comprising a nanoparticle seed layer on one or more surfaces of a current collector; and electrodepositing lithium onto the nanoparticle seed layer of the substrate to form a lithium metal-coated substrate.

In one or more implementations, a battery can include a housing; one or more battery cells disposed within the housing, an individual battery cell of the one or more battery cells comprising: an electrode layer including (i) a seed layer comprised of a number of fused nanoparticles and (ii) a lithium metal layer disposed on the number of fused nanoparticles; one or more separator layers; and one or more electrolyte layers comprising an electrolyte.

### BRIEF DESCRIPTION OF THE DRAWINGS

FIG. 1 is a diagram of a process to produce a nanoparticle seed layer on a surface of a current collector layer.

FIG. 2 is a diagram illustrating an example process to produce a lithium metal coated substrate.

### DETAILED DESCRIPTION

Nanoparticles of a variety of materials, across a diversity of geometries (rods, spheres, wires, etc.) can possess exceptional surface area to mass and surface area to volume ratios. Thus, three-dimensional structures composed of nanoparticles can provide a relatively high surface area substrate suitable for relatively uniform, lateral Li metal deposition in comparison to metallic foam architectures. Such architectures can be deposited on top of a separate planar current collector, essentially providing a “seed layer” for the deposition of Li metal, while also providing a low-resistance electrical connection to the current collector itself. Nanoparticles used to construct such a seed layer can be metallic (i.e., possessing low bulk electrical resistivity), and can be packed within the seed layer to a fairly high packing density, while still maintaining sufficient pore volume between particles to provide space for Li metal deposition and a self-limiting SEI. As a result, the seed layer architectures described herein can maximize available surface area for Li deposition while minimizing the thickness of the seed layer architectures. The seed layer architectures also include a minimum pore volume to accommodate growth of the Li metal layer and any associated SEI, while also minimizing the required thickness of the Li metal layer at full charge to prevent disintegration of the SEI due to volumetric growth of the Li metal layer.

The application of nanoparticles to the surface of a current collector can be accomplished by producing stable colloidal suspensions of nanoparticles within a solvent when the nanoparticles are surface-functionalized with appropriate ligands, essentially generating a nanoparticle “ink”. Such inks can also be formulated to a high solid content of nanoparticles without compromising colloidal stability. In some instances, the inks may comprise appropriate molecular precursors, which when exposed to a post-treatment, generate a porous thin solid film comprising nanoparticles. Once a suitable ink has been generated, it can be applied to the surface of a current collector using coating techniques employed to apply solutions or slurries to flat substrates, such as spray or slot-die coating. In various examples, applying the ink to the surface of a current collector can be performed using techniques that can be used to apply graphite active materials to the anode current collector in existing LIB processes, such as slot-die slurry casting process. As a result, from a manufacturing perspective, the existing graphite slot-die coating process can be repurposed to deposit a colloidal nanoparticle ink or a molecular precursor ink instead of a graphite slurry. This provides a manifest advantage for nanoparticle-based seed layers as described herein over other textured three-dimensional current collectors, as the deposition of nanoparticle seed layers can be accomplished using existing standard LIB manufacturing equipment. Whereas, in contrast, applying foam-based nanostructures or microstructures adds operations to existing systems used to manufacture lithium-ion batteries that include graphite coated electrodes.

The ligands used to functionalize the surface of nanoparticles to render them dispersible within a solvent as a colloidal solution play another key role in the formation of a nanoparticle seed layer, namely, that of a pore-generating species. Once a nanoparticle ink is applied to the surface of a current collector, what remains immediately after the application is a “wet” film composed of ligand-functionalized nanoparticles and residual solvent. After the solvent evaporates, what remains is a “dry” film of stacked ligand-functionalized nanoparticles. The dry film can then be exposed to a moderate heat treatment to allow the nanoparticles to bond or “neck”, i.e., form small sintered inter-particle connections. Surface ligands are usually sufficiently labile on nanoparticle surfaces to allow such necking to occur. At the same time, the nanoparticles can also form small sintered connections to the underlying current collector. Once the nanoparticles have formed sintered connections to each other and to the underlying current collector, the nanoparticles have formed a mechanically stable matrix. Then, the ligands can be removed by another heat treatment or through a chemical treatment, leaving behind empty pores. After removal of the ligands, what remains is a porous, free-standing nanoparticle matrix (the “seed layer”) on top of a current collector, which can then be employed as a substrate for Li metal deposition.

In one or more further examples, can be fused and sintered to themselves and to an underlying current collector to yield a porous, free-standing nanoparticle matrix. In at least some examples, the nanoparticle matrix can be formed from nanoparticles fabricated from inks comprising molecular precursors.

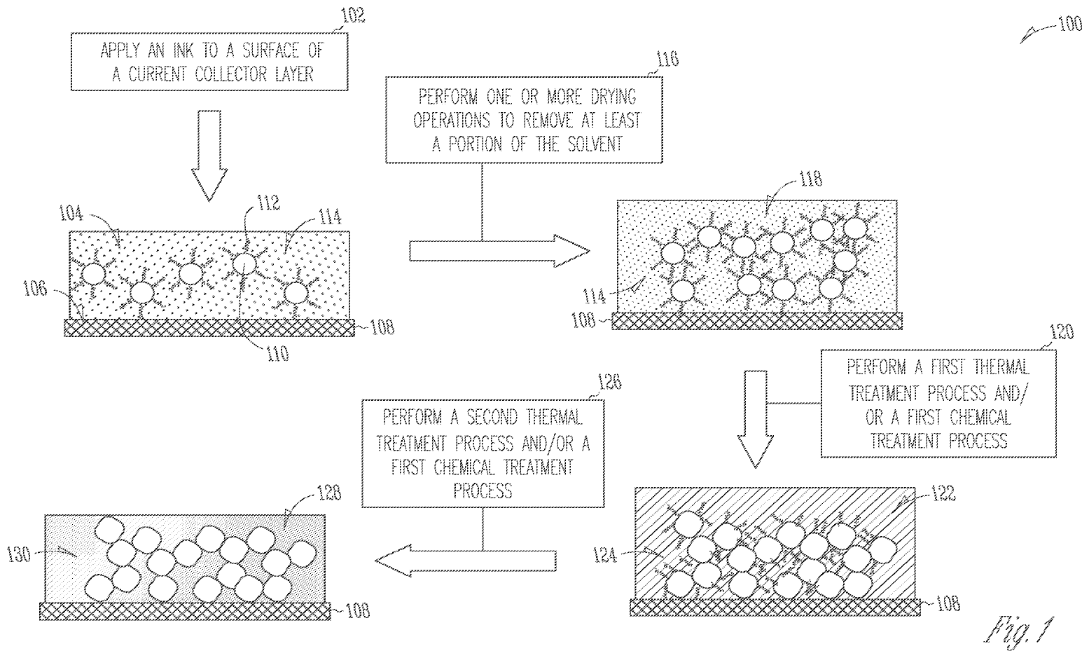

FIG. 1 is a diagram of a process 100 to produce a nanoparticle seed layer on a surface of a current collector layer. The process 100 can include an operation 102 of applying an ink 104 to a surface 106 of a current collector layer 108. In one or more illustrative examples, the ink 104 can be applied to the surface 106 of the current collector layer 108 via a solution-phase thin film coating process. In one or more illustrative examples, the solution-phase coating process can include at least one of a slot-die coating process, a spray coating process, an aerosol coating process, a bath coating process, a gravure coating process, a comma coating process, or a dip coating process. The current collector layer 108 can comprise a metallic material. To illustrate, the current collector layer 108 can comprise a foil.

The ink 104 can include a number of nanoparticles 110. One or more ligands 112 can be coupled to individual nanoparticles 110. The individual combinations of nanoparticles 110 with the one or more ligands 112 can result in ligand-functionalized nanoparticles 114 disposed within the ink 104. The ink 104 can also comprise a solvent in which the nanoparticles 110 are dispersed. In one or more examples, the ink 104 can be applied on both sides of the current collector layer 108. In one or more additional examples, the ink 104 can be applied to one side of the current collector layer 108.

Critical design parameters for the ink 104 can include nanoparticle material, size, and geometry, as well as composition and size of the nanoparticle surface-functionalizing ligand. In addition, solids content of the nanoparticles 110 and associated ligands 112 within the ink 104 is a critical variable. Size of the nanoparticles 110, for instance, can vary from 0.5 nanometers (nm) to 500 nm, from 0.5 nm to 100 nm, from 100 nm to 250 nm, from 50 nm to 300 nm, from 250 nm to 500 nm, from 200 nm to 400 nm, or from 300 nm to 500 nm in diameter in the case of spherical nanoparticles. Size of the ligands 112 can be characterized in terms of molecular weight, ranging, for example, from 20 Da to 10 kDa, from 10 Da to 1 kDa, from 100 Da to 500 Da, from 500 Da to 1500 Da, from 1 kDa to 10 kDa, from 5 kDa to 10 kDa, from 1 kDa to 5 kDa, from 2 kDa to 6 kDa, from 3 kDa to 7 kDa, or from 4 kDa to 8 kDa. Solids content of the ink 104 can range from 1% to 90%, for instance, where solids content is defined as the sum of the mass of nanoparticles 110 and ligands 112 divided by solvent mass. In one or more illustrative examples, the solids content can be from 1% to 10%, from 5% to 20%, from 15% to 30%, from 25% to 40%, from 30% to 50%, from 40% to 60%, from 50% to 70%, from 60% to 80%, from 70% to 90%, from 85% to 95%, or from 90% to 99%.

In one or more examples, the ligands 112 can act as an ion conductor, and therefore may not need to be removed from the “dry” film by a technique such as combustion or dissolution, because it provides ionic conductivity in the manner of an electrolyte. In various examples, the ligands 112 can include a molecule having a chelating group that aids in dispersion of the nanoparticles 110 in a solvent of the ink 104.

The nanoparticles 110 can include one or more metallic materials. The one or more metallic materials can have a bulk resistivity of 1×10⁻¹² Ohm-cm to 1 Ohm-cm. In addition, the nanoparticles 110 can include one or more semiconducting materials. The one or more semiconducting materials can have a bulk resistivity of 1 Ohm-cm to 1000 Ohm-cm. In one or more further examples, the nanoparticles 110 can include one or more insulating materials. The one or more insulating materials can have a bulk resistivity of 1000 Ohm-cm to 1×10¹³ Ohm-cm. In one or more illustrative examples, the bulk resistivity can be determined at temperatures from 20° C. to 30° C. In various examples, the nanoparticles 110 may not be intrinsically metallic, but may be semiconducting or even electrically insulating in nature. In one or more illustrative examples, the nanoparticles 110 can be characterized as sufficiently electrically conductive to avoid introducing an excessive direct current (DC) internal resistance during operation of a battery comprising the nanoparticles 110. The absence of excessive DC current can take place despite the nanoparticles 110 being semiconducting or insulating. In one or more examples, a battery in which the nanoparticles 110 are located may rely on the electrical conductivity of a Li metal layer of the battery to ensure good power capability rather than relying on the conductivity of the nanoparticles 110. Semiconducting or insulating nanoparticles 110 can also be modified to have metallic properties through a subsequent thermal and/or chemical treatment performed on a final seed layer of the nanoparticles 110 or through coating with a very thin layer of metal. In various examples, the nanoparticles 110 can be rendered electrically conductive by electroless plating with one or more metals.

In one or more examples, two different compositions of nanoparticles 110 can constitute the seed layer. For example, first nanoparticles having a first composition can be used to provide structural integrity to the seed layer, while second nanoparticles having a second composition can be used to provide sites for catalyzed and controlled nucleation of Li metal. In one or more illustrative examples, the nanoparticles 110 can be a “core-shell” type of nanoparticle, wherein the nanoparticles 110 can include two different materials. To illustrate, the nanoparticles 110 can include an inner core comprised of one or more first materials, and an outer shell disposed around the core comprised of one or more second materials. In these scenarios, the core can provide structural integrity to the seed layer, while the shell can provide sites for catalyzed and controlled nucleation of Li metal. In one or more additional examples, the nanoparticles 110 can have a spherical geometry. To illustrate, the nanoparticles 110 can have a multi-faceted polyhedral geometry.

The nanoparticles 110 can have a dimension from 1 Angstrom to 100 nm, from 100 Angstroms to 100 nm, from 100 Angstroms to 1 nm, from 1 nm to 100 nm, from 10 nm to 100 nm, from 10 nm to 50 nm, or from 50 nm to 100 nm. In situations where the nanoparticles 110 have a spherical geometry, the nanoparticles 110 can have a diameter from 1 Angstrom to 100 nm, from 100 Angstroms to 100 nm, from 100 Angstroms to 1 nm, from 1 nm to 100 nm, from 10 nm to 100 nm, from 10 nm to 50 nm, or from 50 nm to 100 nm.

The ink 104 can also include a number of additives. The additives can include one or more organic molecules. For example, the additives can be included in the ink 104 to further modify the porosity and packing density of the nanoparticles 108 within the seed layer. To illustrate, additives included in the ink can include one or more rheology-modifying agents or one or more porosity-modifying agents.

The additives may not provide surface functionalization of the nanoparticles 108 as provided by the ligands 110. The additives may modify the porosity within the final seed layer. The additives are selected to avoid compromising the colloidal stability of the ink 104 and may also be easily removed from a film formed from the ink 104 by moderate heat treatment and/or chemical treatment. Examples of the additives may include polymers that promote uniform self-assembly of nanoparticles in thin films but which can be relatively easily removed through combustion or dissolution. In one or more additional examples, additives can also be introduced into the ink 104 to modify the rheology of the ink 104 in order to improve the coating of the ink 104 on the surface 106 of the current collector layer 108 via one or more solution-phase coating techniques.

The process 100 can also include, at operation 116, performing one or more drying processes to remove at least a portion of the solvent included in the ink 104 and to produce a film 118. The film 118 can include the ligand-functionalized nanoparticles 114.

After the drying process is performed at operation 116, one or more additional thermal treatment processes, one or more chemical treatment processes, or one or more thermal treatment processes and one or more chemical treatment processes can be performed. The one or more thermal treatments can include one or more heat treatments. In one or more additional examples, the one or more thermal treatments can include non-convective thermal treatments. In one or more illustrative examples, the non-convective thermal treatments can include at least one of laser-assisted sintering, microwave-assisted sintering, or optical flash sintering. Critical variables related to the thermal treatment processes and/or the chemical treatment processes can include heat treatment temperature as well as ambient gas composition within a heat treatment chamber.

Additionally, at operation 120, the process 100 can include performing at least one of a first thermal treatment process or a first chemical treatment process with respect to the film 118. In one or more examples, the first thermal treatment process and/or the first chemical treatment process can be performed within a chamber of a system used to produce a nanoparticle seed layer. In one or more examples, a first thermal treatment process can be conducted at a temperature sufficiently high and for a duration to promote necking between nanoparticles, without dramatically reducing overall nanoparticle surface area due to recrystallization. For example, the first thermal treatment process can be performed at temperatures from about 30° C. to 650° C., from 30° C. to 100° C., from 100° C. to 300° C., from 200° C. to 500° C., from 300° C. to 650° C., from 100° C. to 200° C., from 200° C. to 300° C., from 300° C. to 400° C., from 400° C. to 500° C. or from 500° C. to 650° C. The first thermal treatment can also be conducted in an ambient environment that promotes nanoparticle necking without dramatically changing nanoparticle composition. That is, the first thermal treatment process can be conducted in an environment that minimizes oxidation that may take place with respect to the ligand-functionalized nanoparticles 112. In one or more illustrative examples, the first thermal treatment process can be performed in an environment comprised of one or more gases including Nitrogen, Oxygen, Hydrogen, Argon, or one or more combinations thereof. Additionally, the one or more gases can be ionized.

The first chemical treatment process can include exposing the substrate to a bath containing a solution comprising a residual wash solvent and at least one chemical reagent. The bath can be heated to a temperature between 30° C. and 300° C. Additionally, the solution can remove residual organic molecules in the nanostructured seed layer via a dissolution or depolymerization mechanism.

Performing at least one of the first heat treatment process or the first chemical treatment process can produce a modified film 122 that includes a number of intermediate nanoparticle clusters 124. The individual intermediate nanoparticle clusters 124 can include a number of nanoparticles 110 that have been fused together as a result of the first heat treatment process and/or the first chemical treatment process. The individual intermediate nanoparticle clusters 124 can also include a number of ligands 112 coupled to the fused groups of nanoparticles 110. In various examples, at least one of the first heat treatment process or the first chemical treatment process can modify at least one of a shape, volume, or area of the nanoparticles 110 to cause the nanoparticles 110 to become fused to form the intermediate nanoparticle clusters 124.

At operation 126, the process 100 can include performing at least one of a second thermal treatment process or a second chemical treatment process. The second thermal treatment process and/or the second thermal treatment process can produce a seed layer 128. The seed layer 128 can comprise a number of fused nanoparticles 130. In various examples, the second heat treatment process and/or the second chemical treatment process can cause the ligands 112 to be removed from the intermediate nanoparticle clusters 124 to produce the fused nanoparticles 130. The seed layer can have a porosity from 1% by volume pores to 99% by volume pores, from 1% by volume pores to 25% by volume pores, from 5% by volume pores to 20% by volume pores, from 10% by volume pores to 30% by volume pores, from 20% by volume pores to 30% by volume pores, from 30% by volume pores to 40% by volume pores, from 40% by volume pores to 50% by volume pores, from 25% by volume pores to 50% by volume pores, from 50% by volume pores to 75% by volume pores, from 50% by volume pores to 60% by volume pores, from 60% by volume pores to 70% by volume pores, from 70% by volume pores to 80% by volume pores, from 80% by volume pores to 90% by volume pores, or from 90% by volume pores to 99% by volume pores.

In one or more examples, at least a portion of the pores of the seed layer 128 can be filled with a solid electrolyte. In various examples, the pores of the seed layer 128 can be filled using liquid-phase infiltration. The solid electrolyte can include a solid polymer electrolyte. In one or more illustrative examples, the solid polymer electrolyte can comprise a polyethylene oxide. In one or more additional illustrative examples, the solid electrolyte can comprise a composite solid electrolyte that includes a polymer and inorganic filler, one or both of which contribute to Li⁺ ion conductivity, such as polyethylene oxide mixed with Li₇La₃Zr₂O₁₂. In one or more illustrative examples, the solid electrolyte can be comprised of a solid inorganic electrolyte. The solid inorganic electrolyte can be comprised of one or more of the following: Li_{w}LaₓM_{y}O₁₂ (where M is Nb, Ta, or Zr), LiₓMP_{y}S_{z} (where M is Ge or Sn), Li_{w}AlₓM_{y}(PO₄)₃ (where M is Ge or Ti), LiₓTi_{y}M_{z}(PO₄)₃ (where M is Cr, Ga, Fe, Sc, In, Lu, Y or La) or NaₓZr₂Si_{y}PO₁₂, where in all cases, x, y and z represent stoichiometric coefficients. In one or more further examples, the electrolyte can be comprised of a solid polymer electrolyte. The solid polymer electrolyte can comprise one or more of the following polymers: polyethylene oxide (PEO), poly vinyl alcohol (PVA), poly methyl methacrylate (PMMA), poly dimethyl siloxane (PDMS), poly(ethylene glycol) dimethacrylate (PEGDMA), poly vinyl pyrollidone (PVP). Such polymers, when combined with lithium salts such as LiClO₄, LiPF₆ or LiNO₃, among others, can yield a solid polymer electrolyte thin film. In one or more illustrative examples, the solid electrolyte can comprise a lithium-containing salt and an organic solvent. The organic solvent can comprise one or more of the following molecules: ethylene carbonate, ethyl methyl carbonate, propylene carbonate, glyme, diglyme, dioxolane, vinylene carbonate, propane sultone, diethyl carbonate, dimethyl carbonate, sulfolane. Additionally, the organic solvent can comprise an ionic liquid such as a salt containing a quaternary phosphorous or nitrogen cation such as 1-ethyl-3-methyl imidazolium or 1-butyl-1-methyl pyrrolidinium. In one or more examples, the lithium-containing salt can comprise one or more of the following molecules: lithium hexafluorophosphate, lithium perchlorate, lithium difluoro(oxalate)borate, lithium trifluoromethanesulfonate, lithium tetrafluoroborate, lithium bis(trifluoromethanesulfonimide), lithium bis(fluorosulfonyl)imide.

In one or more examples, the surface of the seed layer 128 can be further stabilized by the application of a thin-film nanolayer composed of a material that is different from the material of the seed layer 128. Such a material may be described as an “artificial solid-electrolyte interphase (SEI)”. The artificial SEI serves to mitigate the formation of electrochemically-generated SEI during operation of any battery cell that includes seed layer 128. In various examples, the artificial SEI can be applied to the surface of the seed layer 128 via solution-deposition techniques. In one or more illustrative examples, the artificial SEI can be applied to the surface of the seed layer 128 according to one or more implementations described in U.S. patent application Ser. No. 16/244,024, which is incorporated by reference herein in its entirety.

The second thermal treatment process can be distinct from the first thermal treatment process in terms of process conditions such as process environment and process temperature. In one or more additional examples, the second thermal treatment process and the first thermal treatment process can be performed under the same or similar conditions. In one or more examples, the fused nanoparticles 130 can comprise sintered inter-particle connections. In various examples, the fused nanoparticles 130 can be produced using non-convective thermal techniques, such as laser-assisted sintering, optical flash sintering or microwave-assisted sintering. In various examples, the second chemical treatment process can be distinct from the second chemical treatment process. Further, the second chemical treatment process and the first chemical treatment process can be performed under the same or similar conditions. In various examples, the at least one of the second thermal treatment process or the second chemical treatment process can be optional.

In one or more further examples, to help reduce oxidation of metallic nanoparticles, nanoparticles can be applied to a current collector that are free of ligands. In these scenarios, metal-organic decomposition inks can be applied to a current collector. The inks can include a solvent. In one or more illustrative examples, an ink applied to the current collector can include an organo-metallic ink. The ink can include at least one of a solvent or a porogen. In various examples, the inks can include one or more additives to stabilize the inks. The ink can include metal-organic nanoparticles that are precursors used to form the nanstructured seed layer. In at least some examples, at least one of one or more heat treatments or one or more chemical treatments can be applied to cause the organometallic precursors included in the ink to become fused to an underlying current collector and to themselves to form the nanostructured seed layer. In various examples, the one or more heat treatments can include non-convective thermal techniques, such as laser-assisted sintering, optical flash sintering or microwave-assisted sintering. The one or more heat treatments can be performed at temperatures from about 50° C. to about 500° C. for a duration from about 1 minute to about 6 hours. The one or more heat treatments and/or one or more chemical treatments can be performed in an inert atmosphere. The inert atmosphere can be performed in a reducing environment that includes an inert gas, such as argon and/or nitrogen. The final product can include a metallic nanoparticle film that serves as a seed layer for the deposition of a metal layer on the current collector substrate having the nanostructured seed layer. In this way, the fused nanoparticles 130 can be produced using a process that is different from the process that utilizes ligand-functionalized nanoparticels.

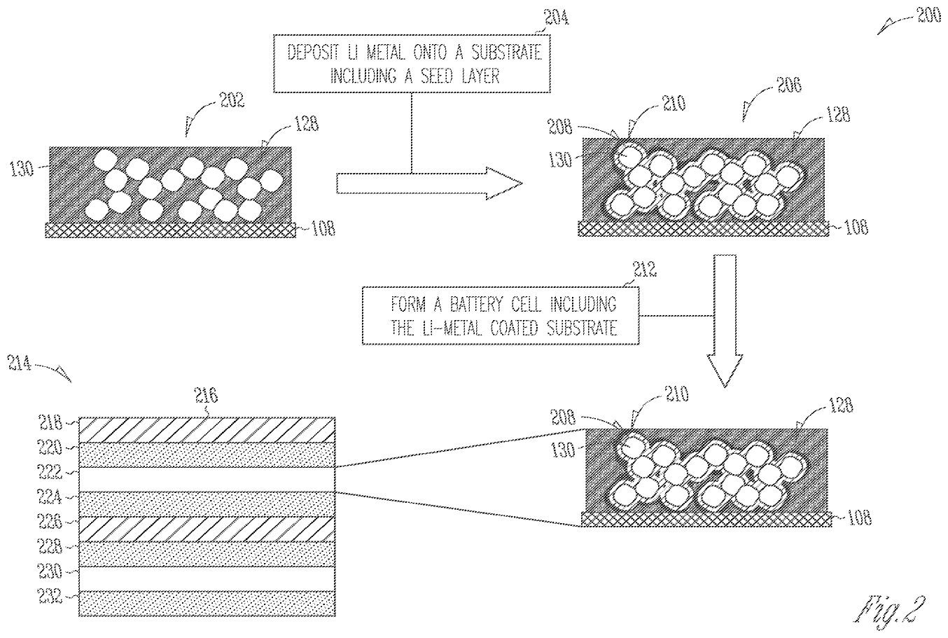

FIG. 2 illustrates an example process 200 to produce a lithium metal coated substrate. The process 200 can include providing a substrate 202 that includes the current collector layer 108 and the seed layer 128 that comprises the fused nanoparticles 130. At 204, the process 200 can include depositing lithium (Li) metal onto the substrate 202. Depositing the Li metal onto the substrate 202 can produce a lithium metal-coated substrate 206. The lithium metal-coated substrate 206 can comprise the fused nanoparticles 130 with a Li metal layer 208 disposed on the fused nanoparticles 130. Depositing the Li metal onto the substrate 202 can be performed using an electrodeposition process. The electrodeposition process can take place in an electrodeposition bath. The electrodeposition bath can comprise an electrolyte, a lithium-containing salt, and a counter electrode. The electrolyte can comprise a lithium-containing salt and an organic solvent. The counter electrode can comprise Lithium metal.

The organic solvent can comprise one or more of the following molecules: ethylene carbonate, ethyl methyl carbonate, propylene carbonate, glyme, diglyme, dioxolane, vinylene carbonate, propane sultone, diethyl carbonate, dimethyl carbonate, sulfolane. Additionally, the organic solvent can comprise an ionic liquid such as a salt containing a quaternary phosphorous or nitrogen cation such as 1-ethyl-3-methyl imidazolium or 1-butyl-1-methyl pyrrolidinium. In one or more examples, the lithium-containing salt can comprise one or more of the following molecules: lithium hexafluorophosphate, lithium perchlorate, lithium difluoro(oxalate)borate, lithium trifluoromethanesulfonate, lithium tetrafluoroborate, lithium bis(trifluoromethanesulfonimide), lithium bis(fluorosulfonyl)imide.

In one or more examples, the Li metal layer 208 can be an initial, pre-deposition layer. In various examples, the Li metal can be electrodeposited onto the substrate 202 within a bath containing Li metal or other suitable counter electrode and Li salts. The bath can also include one or more electrolytes, such as ionic liquids. In one or more illustrative examples, solid-electrolyte-interphase (SEI) 210 can be formed on the Li metal layer 208. The advantages of performing the pre-deposition process can include:
a. introducing a quantity of Li metal onto the substrate 202 prior to forming a battery cell, can provide a “reservoir” of excess Li to compensate for Li consumed to form the 210 SEI (or due to other parasitic losses) during battery operation
b. pre-generating an SEI 210 on top of the pre-deposited Li metal layer 208, can eliminate some quantity of the formation of SEI 210 during battery operation.
   In one or more implementations, the pre-deposition process performed at operation 204 can be conducted using roll-to-roll electrodeposition bath equipment.

The process 200 can also include, at operation 212, forming a battery cell 214 that includes the lithium metal-coated substrate 206. In one or more examples, the lithium metal-coated substrate 206 can comprise an electrode of the battery cell 214. In one or more illustrative examples, the lithium metal-coated substrate 206 can comprise an anode of the battery cell 214. The battery cell 214 can be one of a plurality of battery cells included in a battery. The average thickness of the lithium metal layer 208 when the battery is in a fully charged state ranges from 1 Angstrom to 10000 nm. In various examples, the average thickness of the lithium metal layer 208 in can increase when the battery is charged with respect to the initial thickness of the lithium metal layer 208 of the lithium metal-coated substrate 206.

The battery can be a power supply used in a number of implementations. For example, the battery can be a power source for a consumer electronics device, such as a smart phone, a laptop computing device, a wearable computing device, a tablet computing device, a portable gaming device, and/or a desktop computer device. Additionally, the battery can be a power source for an electric vehicle. In one or more further examples, the battery can be a power source for other vehicles, such as aircraft and unmanned aerial vehicles. The battery can also provide energy storage as part of an electricity grid that provides power to buildings, municipalities, and the like.

The battery cell 214 can include a housing 216. The housing 216 can be comprised of

one or more metallic materials. The housing 216 can also be comprised of one or more polymeric materials. A number of layers can be disposed within the housing 216. For example, one or more separator layers can be disposed within the housing 216. In addition, one or more electrolyte layers can be disposed within the housing 216. Further, a number of electrode layers can be disposed within the housing 216. For example, a number of anode layers and a number of cathode layers can be disposed within the housing 216.

In one or more illustrative examples, a first separator layer 218 can be disposed within the housing 216. Additionally, a first electrolyte layer 220 can be disposed within the housing 216. Further, a first electrode layer 222 can be disposed within the housing 216. In the illustrative example of FIG. 2, the lithium metal-coated substrate 206 can comprise the first electrode layer 222. A second electrolyte layer 224 can be disposed in the housing 216 in addition to a second separator layer 226. In various examples, the housing 216 can include a third electrolyte layer 228 and a second electrode layer 230. In one or more examples, the housing 216 can also include a fourth electrolyte layer 232. In one or more instances, the first electrode layer 222 can correspond to an anode layer and the second electrode layer 230 can correspond to a cathode layer. In one or more additional instances, the first electrode layer 222 can correspond to a cathode layer and the second electrode layer 230 can correspond to an anode layer. In scenarios where the first electrode layer 222 comprises an anode layer, the second electrode layer 230 can include a cathode layer that is comprised of LiNiₓMn_{y}Co_{z}O₂, LiNiₓCo_{y}Al_{z}O₂, LiMnₓNi_{y}O_{z}, LiMnO₂, LiFePO₄, LiMnPO₄, LiNiPO₄, LiCoPO₄, LiV₂O₅, sulfur or LiCoO₂ where x, y and z are stoichiometric coefficients.

Although the illustrative example of FIG. 2 shows an arrangement of layers of the battery cell 214, in additional implementations, a different number and a different arrangement of layers can be disposed in the housing 216 of the battery cell 214. Further, additional layers not shown in the illustrative example of FIG. 2 can also be disposed in the housing 216.

A numbered non-limiting list of aspects of the present subject matter is presented below.

Aspect 1. A method for producing a substrate comprising a nanostructured seed layer on one or more surfaces of a current collector, the method comprising: providing an ink comprising a solution comprising at least ligand-functionalized nanoparticles and a solvent; applying a thin wet film of the ink to the current collector using a solution-phase thin-film coating process; drying the thin wet film to produce a thin dry film of ligand-functionalized nanoparticles; and performing one or more thermal treatments and/or chemical treatments to the thin dry film, thereby producing a substrate comprising a free-standing, porous nanostructured seed layer on one or more surfaces of a current collector.

Aspect 2. The method of aspect 1, wherein the nanoparticle is composed of a metal.

Aspect 3. The method of aspect 2, wherein the metal possesses a bulk resistivity of 1×10⁻¹² Ohm-cm to 1 Ohm-cm.

Aspect 4. The method of any one of aspects 1-3, wherein the nanoparticle is composed of a semiconductor.

Aspect 5. The method of aspect 4, wherein the semiconductor possesses a bulk resistivity of 1 Ohm-cm to 1000 Ohm-cm.

Aspect 6. The method of any one of aspects 1-6, wherein the nanoparticle is composed of an insulator.

Aspect 7. The method of aspect 6, wherein the insulator possesses a bulk resistivity of 1000 Ohm-cm to 1×10¹³ Ohm-cm.

Aspect 8. The method of any one of aspects 1-7, wherein the nanoparticle possesses a spherical geometry.

Aspect 9. The method of any one of aspects 1-8, wherein the nanoparticle possesses a multi-faceted polyhedral geometry.

Aspect 10. The method of aspect 9, wherein the nanoparticle possesses a diameter between 1 Angstrom and 100 nm.

Aspect 11. The method of aspect 10, wherein any dimension of the nanoparticle polyhedral geometry possesses a length between 1 Angstrom and 100 nm.

Aspect 12. The method of any one of aspects 1-11, wherein the ligand is a molecule comprising a chelating group that coordinates with nanoparticle surfaces and a solubilizing group that renders the nanoparticle dispersible in a solvent.

Aspect 13. The method of any one of aspects 1-12, comprising adding organic molecules to the ink in step (a).

Aspect 14. The method of any one of aspects 1-13, wherein the dry film in step (c) is subjected to one or more heat treatments ranging in temperature from 30 to 650° C.

Aspect 15. The method of aspect 14, wherein the one or more thermal treatments is performed in an ambient atmosphere containing gases composed of Nitrogen, Oxygen, Hydrogen, Argon, or some combination thereof.

Aspect 16. The method of aspect 15, wherein one or more of the gases are ionized.

Aspect 17. The method of any one of aspects 1-16, wherein the solution-phase coating process is a slot-die, spray, aerosol, bath, gravure, comma or dip coating process.

Aspect 18. The method of any one of aspects 1-17, wherein the ink further comprises a rheology-modifying agent or a porosity-modifying agent.

Aspect 19. The method of any one of aspects 1-18, wherein the porosity of the nanostructured seed layer ranges from 1%-99%.

Aspect 20. The method of any one of aspects 1-19, wherein the one or more chemical treatments comprises exposing the substrate to a bath containing a solution comprising a residual wash solvent and at least one chemical reagent.

Aspect 21. The method of aspect 20, wherein the bath is heated to a temperature between 30° C. and 300° C.

Aspect 22. The method of aspect 20, wherein the solution removes residual organic molecules in the nanostructured seed layer via a dissolution or depolymerization mechanism.

Aspect 23. The method of any one of aspects 1-22, wherein at least a portion of pores in the nanostructured seed layer are backfilled with a solid electrolyte.

Aspect 24. The method of aspect 23, wherein the solid electrolyte comprises a solid polymer electrolyte.

Aspect 25. The method of aspect 24, wherein the solid polymer electrolyte comprises polyethylene oxide.

Aspect 26. The method of aspect 24, wherein the solid polymer electrolyte comprises one or more of the following polymers: polyethylene oxide (PEO), poly vinyl alcohol (PVA), poly methyl methacrylate (PMMA), poly dimethyl siloxane (PDMS), poly(ethylene glycol) dimethacrylate (PEGDMA), or poly vinyl pyrollidone (PVP).

Aspect 27. The method of aspect 23, wherein the solid electrolyte comprises a composite solid electrolyte comprising a polymer and inorganic filler.

Aspect 28. The method of aspect 27, wherein at least one of the polymer or the inorganic filler contribute to Li⁺ ion conductivity.

Aspect 29. The method of aspect 23, wherein the solid electrolyte comprises polyethylene oxide mixed with Li₇La₃Zr₂O₁₂.

Aspect 30. The method of aspect 23, wherein the solid electrolyte comprises a solid inorganic electrolyte.

Aspect 31. The method of aspect 30, wherein the solid inorganic electrolyte comprises one or more of Li_{w}LaₓM_{y}O₁₂ (where M is Nb, Ta, or Zr), LiₓMP_{y}S_{z} (where M is Ge or Sn), Li_{w}AlₓM_{y}(PO₄)₃ (where M is Ge or Ti), LiₓTi_{y}M_{z}(PO₄)₃ (where M is Cr, Ga, Fe, Sc, In, Lu, Y or La) or NaₓZr₂Si_{y}PO₁₂, x, y and z represent stoichiometric coefficients.

Aspect 32. The method of aspect 23, wherein the solid electrolyte comprises a lithium-containing salt and an organic solvent.

Aspect 33. The method of aspect 32, wherein organic solvent comprises at least one of ethylene carbonate, ethyl methyl carbonate, propylene carbonate, glyme, diglyme, dioxolane, vinylene carbonate, propane sultone, diethyl carbonate, dimethyl carbonate, or sulfolane.

Aspect 34. The method of aspect 32, wherein the organic solvent includes an ionic liquid.

Aspect 35. The method of aspect 34, wherein the ionic liquid comprises a quaternary phosphorous or a nitrogen cation.

Aspect 36. The method of aspect 35, wherein the ionic liquid comprises 1-ethyl-3-methyl imidazolium or 1-butyl-1-methyl pyrrolidinium.

Aspect 37. The method of aspect 32, wherein the lithium-containing salt includes at least one of lithium hexafluorophosphate, lithium perchlorate, lithium difluoro(oxalate)borate, lithium trifluoromethanesulfonate, lithium tetrafluoroborate, lithium bis(trifluoromethanesulfonimide), or lithium bis(fluorosulfonyl)imide.

Aspect 38. The method of any one of aspects 1-37, wherein the current collector is a foil.

Aspect 39. The method of any one of aspects 1-38, where the nanostructured seed layer is rendered electrically conductive by electroless plating with one or more metals.

Aspect 40. The method of any one of aspects 1-19, wherein a non-convective thermal treatment is performed in addition to or in lieu of a heat treatment or chemical treatment.

Aspect 41. The method of aspect 40, wherein the non-convective thermal treatment comprises laser-assisted sintering, microwave-assisted sintering, or optical flash sintering.

Aspect 42. The method of any one of aspects 1-41, where the seed layer is composed of at least two different types of nanoparticles wherein the at least two different nanoparticles are composed of different materials.

Aspect 43. The method of any one of aspects 1-42, wherein the seed layer is composed of core-shell nanoparticles, wherein the core is composed of one material and the shell is composed of a different material.

Aspect 44. The method of any one of aspect 1-43, comprising: forming an artificial solid-electrolyte interphase layer on at least a portion of the seed layer.

Aspect 45. The method of aspect 44, wherein the artificial solid-electrolyte interphase layer includes one or more monolayers.

Aspect 46. The method of aspect 44 or 45, wherein the artificial solid-electrolyte interphase layer includes a metallic material.

Aspect 47. The method of any one of aspects 44-46, wherein the artificial solid-electrolyte interphase layer includes a polymeric material.

Aspect 48. A method for producing a lithium-metal coated substrate, the method comprising: providing a substrate comprising a nanoparticle seed layer on one or more surfaces of a current collector; and electrodepositing lithium onto the nanoparticle seed layer of the substrate to form a lithium metal-coated substrate.

Aspect 49. The method of aspect 48, wherein the substrate comprising the nanoparticle seed layer on one or more surfaces of a current collector is produced by any one of the methods of aspects 1 to 47.

Aspect 50. The method of aspect 48, wherein the electrodepositing occurs in an electrodeposition bath comprising an electrolyte, a lithium-containing salt, and a counter electrode.

Aspect 51. The method of aspect 50, wherein the electrolyte is composed of a lithium-containing salt and an organic solvent.

Aspect 52. The method of aspect 51, wherein the organic solvent comprises one or more of the following molecules: ethylene carbonate, ethyl methyl carbonate, propylene carbonate, glyme, diglyme, dioxolane, vinylene carbonate, propane sultone, diethyl carbonate, dimethyl carbonate, sulfolane.

Aspect 53. The method of aspect 51 or 52, wherein the lithium-containing salt comprises one or more of the following molecules: lithium hexafluorophosphate, lithium perchlorate, lithium difluoro(oxalate)borate, lithium trifluoromethanesulfonate, lithium tetrafluoroborate, lithium bis(trifluoromethanesulfonimide), lithium bis(fluorosulfonyl)imide.

Aspect 54. The method of aspect 51, wherein the organic solvent comprises an ionic liquid such as a salt containing a quaternary phosphorous or nitrogen cation such as 1-ethyl-3-methyl imidazolium or 1-butyl-1-methyl pyrrolidinium.

Aspect 55. The method of aspect 48, wherein the method occurs prior to assembly of the lithium-metal coated substrate with a cathode, an electrolyte, a separator, and a housing to form a battery.

Aspect 56. The method of aspect 55, wherein the average lithium metal thickness on the nanostructured seed layer when the battery is in a fully charged state ranges from 1 Angstrom to 1000 nm.

Aspect 57. The method of aspect 55, wherein the cathode is composed of LiNiₓMn_{y}Co_{z}O₂, LiNiₓCo_{y}Al_{z}O₂, LiMnₓNi_{y}O_{z}, LiMnO₂, LiFePO₄, LiMnPO₄, LiNiPO₄, LiCoPO₄, LiV₂O₅, sulfur or LiCoO₂ where x, y and z are stoichiometric coefficients.

Aspect 58. The method of any one of aspects 48-57, wherein the nanoparticle seed layer is produced according to the method of any one of aspects 1-47.

Aspect 59. A battery comprising a lithium-metal coated substrate produced by any one of the methods of aspects 4 to 58.

Aspect 60. The battery of aspect 59, wherein the average lithium metal thickness

on the nanostructured seed layer when the battery is in a fully charged state ranges from 1 Angstrom to 1000 nm.

Aspect 61. The battery of aspect 59, further comprising a cathode, wherein the cathode is composed of LiNiₓMn_{y}Co_{z}O₂, LiNiₓCo_{y}Al_{z}O₂, LiMnₓNi_{y}O_{z}, LiMnO₂, LiFePO₄, LiMnPO₄, LiNiPO₄, LiCoPO₄, LiV₂O₅, sulfur or LiCoO₂ where x, y and z are stoichiometric coefficients.

Aspect 62. A substrate comprising a nanostructured seed layer on one or more surfaces of a current collector.

Aspect 63. The substrate of aspect 62, wherein the substrate is produced by a method of any one of aspects 1-47.

Aspect 64. A battery comprising: a housing; one or more battery cells disposed within the housing, an individual battery cell of the one or more battery cells comprising: an electrode layer including (i) a seed layer comprised of a number of fused nanoparticles and (ii) a lithium metal layer disposed on the number of fused nanoparticles; one or more separator layers; and one or more electrolyte layers comprising an electrolyte.

Aspect 65. The battery of aspect 64, wherein the seed layer includes a number of pores, and at least a portion of the number of pores are filled with an additional electrolyte.

Aspect 66. The battery of aspect 65, wherein the additional electrolyte is composed of a lithium-containing salt and an organic solvent.

Aspect 67. The battery of aspect 65, wherein the organic solvent comprises one or more of the following molecules: ethylene carbonate, ethyl methyl carbonate, propylene carbonate, glyme, diglyme, dioxolane, vinylene carbonate, propane sultone, diethyl carbonate, dimethyl carbonate, sulfolane

Aspect 68. The battery of aspect 65, wherein the lithium-containing salt comprises one or more of the following molecules: lithium hexafluorophosphate, lithium perchlorate, lithium difluoro(oxalate)borate, lithium trifluoromethanesulfonate, lithium tetrafluoroborate, lithium bis(trifluoromethanesulfonimide), lithium bis(fluorosulfonyl)imide.

Aspect 69. The battery of aspect 65, wherein the organic solvent includes an ionic liquid.

Aspect 70. The battery of aspect 69, wherein the ionic liquid comprises a quaternary phosphorous or a nitrogen cation.

Aspect 71. The battery of aspect 70, wherein the ionic liquid comprises 1-ethyl-3-methyl imidazolium or 1-butyl-1-methyl pyrrolidinium.

Aspect 72. The battery of aspect 65, wherein the additional electrolyte is composed of a solid inorganic electrolyte comprising one or more of the following: Li_{w}LaₓM_{y}O₁₂ (where Mis Nb, Ta, or Zr), Liₓ¬MP_{y}S_{z} (where M is Ge or Sn), Li_{w}AlₓM¬_{y}(PO₄)₃ (where M is Ge or Ti), LiₓTi_{y}M_{z}(PO₄)₃ (where M is Cr, Ga, Fe, Sc, In, Lu, Y or La) or NaₓZr₂Si_{y}PO₁₂, where in all cases, x, y and z represent stoichiometric coefficients.

Aspect 73. The battery of aspect 65, wherein the additional electrolyte is composed of a solid polymer electrolyte comprising one or more of the following polymers: polyethylene oxide (PEO), poly vinyl alcohol (PVA), poly methyl methacrylate (PMMA), poly dimethyl siloxane (PDMS), poly(ethylene glycol) dimethacrylate (PEGDMA), poly vinyl pyrollidone (PVP). Such polymers, when combined with lithium salts such as LiClO₄, LiPF₆, or LiNO₃, among others, can yield a solid polymer electrolyte thin film.

Aspect 74. The battery of aspect 65, wherein the additional electrolyte comprises a composite solid electrolyte comprising a polymer and inorganic filler.

Aspect 75. The battery of aspect 74, wherein at least one of the polymer or the inorganic filler contribute to Li⁺ ion conductivity.

Aspect 76. The battery of aspect 66, wherein the additional electrolyte comprises polyethylene oxide mixed with Li₇La₃Zr₂O₁₂.

Aspect 77. A formulation comprising: a solvent; a plurality of nanoparticles disposed within the solvent, the plurality of nanoparticles having one or more dimensions from about 0.5 nanometers to about 500 nm; one or more ligands coupled to individual nanoparticles of the plurality of nanoparticles, the one or more ligands having a molecular weight from 20 daltons (Da) to 10 kDa.

Aspect 78. The formulation of aspect 77, wherein the one or more ligands functionalize surfaces of at least a portion of the plurality of nanoparticles.

Aspect 79. The formulation of aspect 77 or 78, wherein the one or more ligands include an ion conductive material.

Aspect 80. The formulation of any one of aspects 77-79, wherein the one or more ligands include a molecule having a chelating group.

Aspect 81. The formulation of any one of aspects 77-80, wherein at least a portion of the plurality of nanoparticles are comprised of one or more metallic materials.

Aspect 82. The formulation of any one of aspects 77-80, wherein at least a portion of the plurality of nanoparticles are comprised of one or more semiconducting materials.

Aspect 83. The formulation of any one of aspects 77-80, wherein at least a portion of the plurality of nanoparticles are comprised of one or more insulating materials.

Aspect 84. The formulation of any one of aspects 77-83, wherein the plurality of nanoparticles avoid introducing an excessive direct current resistance during operation of a battery comprising the plurality of nanoparticles.

Aspect 85. The formulation of any one of aspects 77-83, wherein the plurality of nanoparticles comprise a first group of nanoparticles having a first composition and a second plurality of nanoparticles having a second composition.

Aspect 86. The formulation of aspect 85, wherein at least a portion of the plurality of nanoparticles have a core-shell shape with an inner core comprised of one or more first materials and an outer shell disposed around the inner core comprised of one or more second materials.

Aspect 87. The formulation of any one of aspects 77-86, comprising one or more additives.

Aspect 88. The formulation of aspect 87, wherein the one or more additives include at least one of one or more rheology-modifying agents or one or more porosity-modifying agents.

Aspect 89. The formulation of any one of aspects 77-88, having a solids content from about 1% to 90%, the solids content comprising a mass of the plurality of nanoparticles and a mass of the one or more ligands in relation to a mass of the solvent.

Aspect 90. The formulation of any one of aspects 77-89, wherein the formulation is characterized as an ink.

Aspect 91. A method for producing a substrate including a nanostructured seed layer on one or more surfaces of a current collector comprising: providing an ink including a solution comprising at least one or more molecular precursors and a solvent; applying a thin wet film of the ink can be applied to the current collector; performing at least one of one or more thermal treatments or one or more chemical treatments to the thin wet film to produce a substrate comprising a free-standing, porous nanostructured seed layer on one or more surfaces of a current collector.

Aspect 92. The method of aspect 91, wherein the one or more molecular precurusors include one or more metalorganic nanoparticles.

Aspect 93. The method of aspect 92, wheein the ink is applied to the current collector using a solution-phase thin-film coating process.

Aspect 94. The method of any one of aspects 91-93, wherein at least a portion of pores in the nanostructured seed layer are backfilled with a solid electrolyte.

Aspect 95. The method of aspect 94, wherein the solid electrolyte comprises a solid polymer electrolyte.

Aspect 96. The method of aspect 95, wherein the solid polymer electrolyte comprises polyethylene oxide.

Aspect 97. The method of aspect 95, wherein the solid polymer electrolyte comprises one or more of the following polymers: polyethylene oxide (PEO), poly vinyl alcohol (PVA), poly methyl methacrylate (PMMA), poly dimethyl siloxane (PDMS), poly (ethylene glycol) dimethacrylate (PEGDMA), or poly vinyl pyrollidone (PVP).

Aspect 98. The method of aspect 94, wherein the solid electrolyte comprises a composite solid electrolyte comprising a polymer and inorganic filler.

Aspect 99. The method of aspect 98, wherein at least one of the polymer or the inorganic filler contribute to Li⁺ ion conductivity.

Aspect 100. The method of aspect 94, wherein the solid electrolyte comprises polyethylene oxide mixed with Li₇La₃Zr₂O₁₂.

Aspect 101. The method of aspect 94, wherein the solid electrolyte comprises a solid inorganic electrolyte.

Aspect 102. The method of aspect 101, wherein the solid inorganic electrolyte comprises one or more of Li_{w}LaₓM_{y}O₁₂ (where M is Nb, Ta, or Zr), LiₓMP_{y}S_{z} (where M is Ge or Sn), Li_{w}AlₓM_{y}(PO₄)₃ (where M is Ge or Ti), LiₓTi_{y}M_{z}(PO₄)₃ (where M is Cr, Ga, Fe, Sc, In, Lu, Y or La) or NaₓZr₂Si_{y}PO₁₂, x, y and z represent stoichiometric coefficients.

Aspect 103. The method of aspect 94, wherein the solid electrolyte comprises a lithium-containing salt and an organic solvent.

Aspect 104. The method of aspect 103, wherein organic solvent comprises at least one of ethylene carbonate, ethyl methyl carbonate, propylene carbonate, glyme, diglyme, dioxolane, vinylene carbonate, propane sultone, diethyl carbonate, dimethyl carbonate, or sulfolane.

Aspect 105. The method of aspect 103, wherein the organic solvent includes an ionic liquid.

Aspect 106. The method of aspect 105, wherein the ionic liquid comprises a quaternary phosphorous or a nitrogen cation.

Aspect 107. The method of aspect 106, wherein the ionic liquid comprises 1-ethyl-3-methyl imidazolium or 1-butyl-1-methyl pyrrolidinium.

Aspect 108. The method of aspect 103, wherein the lithium-containing salt includes at least one of lithium hexafluorophosphate, lithium perchlorate, lithium difluoro(oxalate)borate, lithium trifluoromethanesulfonate, lithium tetrafluoroborate, lithium bis(trifluoromethanesulfonimide), or lithium bis(fluorosulfonyl)imide.

Aspect 109. The method of any one of aspects 91-108, wherein the current collector is a foil.

Aspect 110. The method of any one of aspects 91-109, where the nanostructured seed layer is rendered electrically conductive by electroless plating with one or more metals.

Aspect 111. The method of any one of aspects 91-110, wherein a non-convective thermal treatment is performed in addition to or in lieu of a heat treatment or chemical treatment.

Aspect 112. The method of aspect 111, wherein the non-convective thermal treatment comprises laser-assisted sintering, microwave-assisted sintering, or optical flash sintering.

Aspect 113. The method of any one of aspects 91-112, where the seed layer is composed of at least two different types of nanoparticles wherein the at least two different nanoparticles are composed of different materials.

Aspect 114. The method of any one of aspects 91-113, wherein the seed layer is composed of core-shell nanoparticles, wherein the core is composed of one material and the shell is composed of a different material.

Aspect 115. The method of any one of aspect 91-114, comprising: forming an artificial solid-electrolyte interphase layer on at least a portion of the seed layer.

Aspect 116. The method of aspect 115, wherein the artificial solid-electrolyte interphase layer includes one or more monolayers.

Aspect 117. The method of aspect 115 or 116, wherein the artificial solid-electrolyte interphase layer includes a metallic material.

Aspect 118. The method of any one of aspects 115-117, wherein the artificial solid-electrolyte interphase layer includes a polymeric material.

Aspect 119. The method of any one of aspects 91-118, wherein the ink comprises a metal-organic precursor.

Aspect 120. The method of aspect 92, wherein the nanoparticles are composed of a metal.

Aspect 121. The method of aspect 120, wherein the metal possesses a bulk resistivity of 1×10⁻¹² Ohm-cm to 1 Ohm-cm.

Aspect 122. The method of aspect 92, wherein the nanoparticle is composed of a semiconductor.

Aspect 123. The method of aspect 122, wherein the semiconductor possesses a bulk resistivity of 1 Ohm-cm to 1000 Ohm-cm.

Aspect 124. The method of aspect 92, wherein the nanoparticle is composed of an insulator.

Aspect 125. The method of aspect 124, wherein the insulator possesses a bulk resistivity of 1000 Ohm-cm to 1×10¹³ Ohm-cm.

Aspect 126. The method of any one of aspects 92-125, wherein the nanoparticle possesses a spherical geometry.

Aspect 127. The method of any one of aspects 92-126, wherein the nanoparticle possesses a multi-faceted polyhedral geometry.

Aspect 128. The method of aspect 127, wherein the nanoparticle possesses a diameter between 1 Angstrom and 100 nm.

Aspect 129. The method of aspect 128, wherein any dimension of the nanoparticle polyhedral geometry possesses a length between 1 Angstrom and 100 nm.

Aspect 130. The method of any one of aspects 91-129, comprising adding organic molecules to the ink.

Aspect 131. The method of any one of aspects 91-130, wherein the dry film is subjected to one or more heat treatments ranging in temperature from 30 to 650° C.

Aspect 132. The method of aspect 131, wherein the one or more thermal treatments is performed in an ambient atmosphere containing gases composed of Nitrogen, Oxygen, Hydrogen, Argon, or some combination thereof.

Aspect 133. The method of aspect 132, wherein one or more of the gases are ionized.

Aspect 134. The method of any one of aspects 91-133, wherein the solution-phase coating process is a slot-die, spray, aerosol, bath, gravure, comma or dip coating process.

Aspect 135. The method of any one of aspects 91-134, wherein the ink further comprises a rheology-modifying agent or a porosity-modifying agent.

Aspect 136. The method of any one of aspects 91-135, wherein the porosity of the nanostructured seed layer ranges from 1%-99%.

Aspect 137. The method of any one of aspects 91-136, wherein the one or more chemical treatments comprises exposing the substrate to a bath containing a solution comprising a residual wash solvent and at least one chemical reagent.

Aspect 138. The method of aspect 137, wherein the bath is heated to a temperature between 30° C. and 300° C.

Aspect 139. The method of aspect 138, wherein the solution removes residual organic molecules in the nanostructured seed layer via a dissolution or depolymerization mechanism.

### EXAMPLES

To illustrate the effectiveness of a nanoparticle seed layer, the following example is presented:
a. 2 nm diameter nanoparticles comprising a metallic material with spherical geometry are functionalized with an appropriate ligand and dispersed within an appropriate solvent such as THE along with pore-generating and rheology-modifying additives to generate a nanoparticle ink.
b. The ink is cast onto a foil current collector and residual solvent is evaporated under ambient conditions, leaving a “dry” film of ligand-functionalized nanoparticles.
c. Successive heat treatments with or without chemical treatments such as ligand dissolution are performed to convert the “dry” film into a free-standing nanoparticle matrix “seed layer” composed of necked nanoparticles remaining on top of the foil current collector. The ligands, additives, ink rheology and other ink design parameters are chosen such that the final seed layer after all heat treatments and chemical treatments is composed of ˜30% nanoparticle by volume, ˜70% open space by volume (porosity). The effective thickness of the seed layer at this composition (including porosity) is ˜32 μm. The total pore volume per cm² of planar foil of the seed layer is ˜2.2×10⁻⁹ m³. The effective volume occupied by the seed layer (including porosity) per cm² of planar foil is ˜3.2×10⁻⁹ m³.
d. A “pre-deposition” process is then performed on the seed layer plus current collector (collectively, the “substrate”) wherein a ˜0.5 Angstrom thick layer of Li metal is uniformly deposited on nanoparticle surfaces from an electrodeposition bath comprising Li metal, Li salts and a combination of electrolytes.
e. The substrate is then combined with a cathode of areal capacity of 3 mAh/cm² and appropriate electrolyte, separator and housing to generate a battery cell. In such a cell, the substrate acts as the anode. Upon assembly, the electrolyte fills the pores of the seed layer, thereby providing diffusion pathways for Li ions throughout the seed layer.
f. The cell is charged to the full areal capacity of 3 mAh/cm². At this state-of-charge, the Li metal layer on all nanoparticle surfaces grows from 0.5 Angstrom to 4.5 Angstroms.
g. The effective volume of Li metal added to the nanoparticle surfaces totals ˜1.6×10⁻⁹ m³ per cm² of planar foil area, substantially less than the available pore volume of 2.2×10⁻⁹ m³ per cm² within the structure, thereby ensuring sufficient space to be occupied by the Li metal. Residual porosity after Li deposition is ˜0.6×10⁻⁹ m³ per cm² of planar foil area, corresponding to ˜19% of total volume occupied by seed layer. Porosity in the final film can be determined by a technique such as Brunauer-Emmett-Teller (BET) theory. This is slightly less than porosity in state-of-the-art Graphite anodes (˜25%). This residual volume is likely to be occupied by electrolyte and SEI.

In the above example, by limiting the growth of the Li metal layer to between 0.5 Angstroms and 4.5 Angstroms, any pre-formed SEI is likely to remain intact because it is not being excessively mechanically strained. As an example, typical 1-10 micron graphite particles in state-of-the-art LIB anodes swell by 10's to 100's of nm during lithiation, with little to no detrimental impact on the SEI.

In the above example, spherical geometry nanoparticles could be replaced by nanoparticles of alternate geometries, such as multi-faceted polyhedra or longer aspect ratio nanoparticles such as nanorods. Other multi-faceted polyhedra (like tetrahedra, for instance), are known to possess higher surface area to volume ratios than spheres. Furthermore, appropriately tailored nanoparticle geometry can help achieve a seed layer architecture that is optimized for high porosity, high surface area to total seed layer volume and high mechanical strength.

In the above example, the resulting thickness occupied by the nanoparticle seed layer (i.e., including porosity) is ˜32 microns, which is approximately 2× the minimum thickness that could be theoretically occupied by the same quantity of Lithium of the above example if deposited as a continuous film of bulk density. However, as previously described, electrodeposited Li metal films on planar current collectors during practical battery operation are far less dense than the bulk density of Li metal due to uneven, dendritic morphology. Furthermore, a 32-micron thick anode layer represents a substantial improvement in volumetric capacity over a corresponding state-of-the-art graphite layer paired with a 3 mAh/cm² cathode; such a graphite layer would normally exceed 80 microns in thickness.

In the above example, the nanoparticles are “monodisperse”, i.e., they all possess a diameter of 2 nm. In an alternative embodiment, the nanoparticles are “polydisperse”, i.e., they possess a range in diameter. In an alternative implementation, the nanoparticles are polydisperse and are not spherical, in which case they possess a range across whichever dimensions are specific to the geometry of the nanoparticle. Such polydispersity can further optimize the seed layer for high porosity, high surface area to total seed layer volume and high mechanical strength.

In one or more additional implementations, nanoparticles of various sizes are applied as multiple sequentially deposited layers instead of a single layer in order to tailor the microstructure and porosity of the seed layer. In such an implementation, some layers may be composed of larger nanoparticles and some may be composed of smaller nanoparticles. For example, the smaller nanoparticles may possess a size distribution with D50 of 1 nm, whereas the larger nanoparticles may possess a size distribution with D50 of 5 nm.

In one or more examples, the structure of the nanoparticle seed layer may be such that it leaves sufficient porosity for Li metal growth but insufficient room to also maintain high penetration of liquid electrolyte coupled with high levels of SEI growth. However, in state-of-the-art graphite anodes, it is known that several nm's of SEI grown on graphite surfaces contribute little added impedance to the cell. Therefore, even in circumstances where the porosity within the nanoparticle seed layer is mostly occupied by SEI, the diffusion of Li ions through SEI is sufficiently high such that the power capability of the cell is not necessarily negatively impacted.

In various examples, a nanoparticle seed layer may be infilled with some quantity of a solid polymer electrolyte such as polyethylene oxide (PEO) to provide ionic conductivity. In one or more implementations, the solid polymer electrolyte maintains high ionic conductivity within the pores of the seed layer while simultaneously preventing the excessive growth of SEI that often results from liquid electrolytes. Furthermore, solid polymer electrolytes are sufficiently elastic so as to easily accommodate growth of a Li metal layer between 0.5 and 4.5 Angstroms as in the above example. An infilled solid polymer electrolyte within a nanoparticle seed layer can also provide improved mechanical integrity to the seed layer, and it can also provide a physical barrier to atmospheric contaminants. As an example, in cases where the nanoparticle seed layer is composed of a metal that is easily oxidized in ambient air, a solid polymer electrolyte layer could act as a protective physical barrier against oxidation, which could reduce the electrical conductivity of the seed layer. In various examples, the infilled solid electrolyte can be comprised of a solid inorganic electrolyte. The solid inorganic electrolyte can be comprised of one or more of the following: Li_{w}LaₓM_{y}O₁₂ (where M is Nb, Ta, or Zr), LiₓMP_{y}S_{z} (where M is Ge or Sn), Li_{w}AlₓM_{y}(PO₄)₃ (where M is Ge or Ti), LiₓTi_{y}M_{z}(PO₄)₃ (where M is Cr, Ga, Fe, Sc, In, Lu, Y or La) or NaxZr₂SiyPO₁₂, where in all cases, x, y and z represent stoichiometric coefficients. In various examples, the infilled solid electrolyte can be comprised of a solid polymer electrolyte. The solid polymer electrolyte can comprise one or more of the following polymers: polyethylene oxide (PEO), poly vinyl alcohol (PVA), poly methyl methacrylate (PMMA), poly dimethyl siloxane (PDMS), poly(ethylene glycol)dimethacrylate (PEGDMA), poly vinyl pyrollidone (PVP). Such polymers, when combined with lithium salts such as LiClO₄, LiPF₆ or LiNO₃, among others, can yield a solid polymer electrolyte.

While specific configurations have been described, it is not intended that the scope be limited to the particular configurations set forth, as the configurations herein are intended in all respects to be possible configurations rather than restrictive. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of configurations described in the specification.

It will be apparent to those skilled in the art that various modifications and variations may be made without departing from the scope or spirit. Other configurations will be apparent to those skilled in the art from consideration of the specification and practice described herein. It is intended that the specification and described configurations be considered as exemplary only, with a true scope and spirit being indicated by the following claims.

1. A method for producing a substrate comprising a nanostructured seed layer on one or more surfaces of a current collector, the method comprising:
a) providing an ink comprising a solution comprising nanoparticles and a solvent, wherein one or more ligands are coupled to individual nanoparticles to form ligand-functionalized nanoparticles;
b) applying a thin wet film of the ink to the current collector using a solution-phase thin-film coating process;
c) drying the thin wet film to produce a thin dry film of the ligand-functionalized nanoparticles; and
d) performing at least one of one or more thermal treatments or one or more chemical treatments to the thin dry film, thereby producing a substrate comprising a free-standing, porous nanostructured seed layer on one or more surfaces of the current collector.

2. The method of claim 1, wherein the nanoparticle is composed nanoparticles are comprised of a metal having a bulk resistivity of 1×10⁻¹² Ohm-cm to 1 Ohm-cm.

3. (canceled)

4. The method of claim 1, wherein the nanoparticle is composed nanoparticles are-comprised of a semiconductor having a bulk resistivity of 1 Ohm-cm to 1000 Ohm-cm.

5. (canceled)

6. The method of claim 1, wherein the nanoparticles are comprised of an insulator having a bulk resistivity of 1000 Ohm-cm to 1×10¹³ Ohm-cm.

7. (canceled)

8. The method of claim 1, wherein the nanoparticles have a spherical geometry.

9. The method of claim 1, wherein the nanoparticles have a multi-faceted polyhedral geometry.

10. The method of claim 9, wherein the nanoparticles have a diameter between 1 Angstrom and 100 nm.

11. (canceled)

12. The method of claim 1, wherein the one or more ligands include a molecule comprising a chelating group that coordinates with nanoparticle surfaces and a solubilizing group that renders the nanoparticles dispersible in a solvent.

13-19. (canceled)

20. The method of claim 1, wherein the one or more chemical treatments comprises exposing the substrate to a bath containing a solution comprising a residual wash solvent and at least one chemical reagent, and the solution removes residual organic molecules in the nanostructured seed layer via a dissolution or depolymerization mechanism.

21. (canceled)

22. (canceled)

23. The method of claim 1, wherein at least a portion of pores in the nanostructured seed layer are backfilled with a solid electrolyte.

24. The method of claim 23, wherein the solid electrolyte comprises a solid polymer electrolyte comprised of at least one of polyethylene oxide (PEO), poly vinyl alcohol (PVA), poly methyl methacrylate (PMMA), poly dimethyl siloxane (PDMS), poly(ethylene glycol)dimethacrylate (PEGDMA), or poly vinyl pyrollidone (PVP).

25-28. (canceled)

29. The method of claim 23, wherein the solid electrolyte comprises polyethylene oxide mixed with Li₇La₃Zr₂O₁₂.

30. The method of claim 23, wherein the solid electrolyte comprises a solid inorganic electrolyte comprised of at least one of Li_{w}LaₓM_{y}O₁₂ (where M is Nb, Ta, or Zr), LiₓMP_{y}S_{z} (where M is Ge or Sn), Li_{w}AlₓM_{y}(PO₄)₃ (where M is Ge or Ti), LiₓTi_{y}M_{z}(PO₄)₃ (where M is Cr, Ga, Fe, Sc, In, Lu, Y, or La), or NaₓZr₂Si_{y}PO₁₂, and wherein x, y and z represent stoichiometric coefficients.

31. (canceled)

32. The method of claim 23, wherein the solid electrolyte comprises a lithium-containing salt and an organic solvent.

33. The method of claim 32, wherein the organic solvent comprises at least one of ethylene carbonate, ethyl methyl carbonate, propylene carbonate, glyme, diglyme, dioxolane, vinylene carbonate, propane sultone, diethyl carbonate, dimethyl carbonate, or sulfolane.

34. The method of claim 32, wherein the organic solvent includes an ionic liquid comprised of a quaternary phosphorous or a nitrogen cation.

35-43. (canceled)

44. The method of claim 1, comprising:
forming an artificial solid-electrolyte interphase layer on at least a portion of the nanostructured seed layer, wherein the artificial solid-electrolyte interphase layer includes one or more monolayers.

45-47. (canceled)

48. A method for producing a lithium-metal coated substrate, the method comprising:
providing a substrate comprising a seed layer on one or more surfaces of a current collector, wherein the seed layer is comprised of a number of fused nanoparticles; and
electrodepositing lithium onto the seed layer of the substrate to form a lithium metal-coated substrate.

49. The method of claim 48, wherein:
electrodepositing lithium onto the seed layer occurs in an electrodeposition bath comprising (i) an electrolyte comprising a lithium-containing salt and an organic solvent and (ii) a counter electrode;
the organic solvent comprises (i) an ionic liquid comprising a salt including a quaternary phosphorous or a nitrogen cation or (ii) at least one of ethylene carbonate, ethyl methyl carbonate, propylene carbonate, glyme, diglyme, dioxolane, vinylene carbonate, propane sultone, diethyl carbonate, dimethyl carbonate, or sulfolane; and
the lithium-containing salt comprises at least one of lithium hexafluorophosphate, lithium perchlorate, lithium difluoro(oxalate)borate, lithium trifluoromethanesulfonate, lithium tetrafluoroborate, lithium bis(trifluoromethanesulfonimide), or lithium bis(fluorosulfonyl)imide.

50. A battery comprising:
a housing;
one or more battery cells disposed within the housing, an individual battery cell of the one or more battery cells comprising: an electrode layer including (i) a seed layer comprised of a number of fused nanoparticles and (ii) a lithium metal layer disposed on the number of fused nanoparticles;
one or more separator layers; and
one or more electrolyte layers comprising an electrolyte.
